(19) United States
(12) Patent Application Publication
(10) Pub. No.: US 2013/0104649 A1
(43) Pub. Date: May 2, 2013

(54) SENSOR DEVICE

(71) Applicant: AISAN KOGYO KABUSHIKI KAISHA, Aichi-ken (JP)

(72) Inventors: Jiro Oikawa, Tokai-shi (JP); Nobuhiro Kato, Tokai-shi (JP)

(73) Assignee: AISAN KOGYO KABUSHIKI KAISHA, Aichi-ken (JP)

(21) Appl. No.: 13/659,157

(22) Filed: Oct. 24, 2012

(30) Foreign Application Priority Data
Nov. 2, 2011 (JP) 2011-241412
Jun. 28, 2012 (JP) 2012-145275

(51) Int. Cl. G01F 23/24; G01N 9/00

(52) U.S. Cl. 73/32 R; 73/304 R

(57) ABSTRACT

A sensor device may comprise a base portion extending in a depth direction of a container, a pair of electrodes attaching to a surface of the base portion and a filter portion surrounding the pair of electrodes. In a plan view perpendicular to the depth direction of the container, a measuring range in which the pair of electrodes may be disposed and a non-measuring range in which the pair of electrodes may be not disposed are provided in a circumferential direction with the base portion at a center. The filter portion may comprise a filter, and a wall having a lower liquid permeability than the filter. At least a part of the wall may be located within the measuring range.

### CROSS-REFERENCE TO RELATED APPLICATIONS

This application claims priorities to Japanese Patent Application No. 2011-241412, filed on Nov. 2, 2011 and Japanese Patent Application No. 2012-145275, filed on Jun. 28, 2012, the contents of which are hereby incorporated by reference into the present application.

### TECHNICAL FIELD

The present application discloses a sensor device.

### DESCRIPTION OF RELATED ART

Japanese Patent Application Publication No. 2007-292724 discloses a sensor device comprising a fluid detecting portion, an entire periphery of which is surrounded by a filter. In the sensor device, foreign matters and air bubbles are prevented from adhering to the fluid detecting portion by the filter.

### SUMMARY

There is a sensor device that identifies, based on capacitance of a pair of electrodes, characteristics of liquid such as a level of liquid. The capacitance of the pair of electrodes changes according to a length of the electrodes immersed in the liquid. Therefore, if the length of the electrodes immersed in the liquid changes because of rolling of a liquid surface, the capacitance of the pair of electrodes changes although there is no change in the characteristics of the liquid. In this specification, a sensor device is provided that reduces an influence due to the rolling of the liquid surface while preventing foreign matters and the like from adhering to the pair of electrodes.

A sensor device disclosed in the specification may comprise a base portion, a pair of electrodes, and a filter portion. The base portion may be configured to extend in a depth direction of a container when the base portion is disposed within the container containing liquid. The pair of electrodes may be configured to attach to a surface of the base portion and extend in the depth direction of the container. The filter portion may be configured to surround the pair of electrodes. In a plan view perpendicular to the depth direction of the container, a measuring range in which the pair of electrodes is disposed and a non-measuring range in which the pair of electrodes is not disposed may be provided in a circumferential direction with the base portion at a center. The filter portion may comprise a filter, and a wall having a lower liquid permeability than the filter. At least a part of the wall may be located within the measuring range.

In the sensor device, the pair of electrodes is surrounded by the filter portion. Therefore, it is possible to prevent foreign matters and the like from adhering to the pair of electrodes. The wall having a relatively low liquid permeability is disposed within the measuring range where the pair of electrodes is provided. A flow of liquid flowing from an outer side of the filter portion to the pair of electrodes is suppressed by the wall. Therefore, it is possible to reduce the rolling of the liquid surface around the pair of electrodes.

### BRIEF DESCRIPTION OF DRAWINGS

FIG. 1 shows a disassembled view of a sensor device according to a first embodiment;

FIG. 2 shows the sensor device according to the first embodiment;

FIG. 3 shows a sensor device according to a second embodiment;

FIG. 4 shows a diagram for explaining a measuring range and a non-measuring range of a detecting portion in the first embodiment;

FIG. 5 shows a diagram for explaining a measuring range and a non-measuring range of a detecting portion in a modification;

FIG. 6 shows a sensor device according to a third embodiment;

FIG. 7 shows a sensor device according to a fourth embodiment;

FIG. 8 shows a sensor device according to a fifth embodiment; and

FIG. 9 shows a detecting portion in the fifth embodiment.

### DETAILED DESCRIPTION

In one aspect of the present teachings, the sensor device comprising the base portion, the pair of electrodes, and the filter portion may further comprise an identifying device configured to identify a level of the liquid, a density of a specific material contained in the liquid, or a combination thereof based on a signal supplied to the pair of electrodes. For example, in a case where the level of the liquid is identified by the identifying device, the level around the pair of electrodes may be suppressed from changing because of the roiling of the liquid surface. Consequently, an error in identifying the level of the liquid may be suppressed from occurring because of the rolling of the liquid surface.

On the other hand, in a ease where the density of the material is identified, predetermined portions of the pair of electrodes (e.g., the entire electrodes) need to be immersed in the liquid. Therefore, if the portions of the pair of electrodes that need to be immersed in the liquid are exposed from the liquid because of roiling of a liquid surface, the capacitance of the pair of electrodes changes because of the exposure of the portions. As a result, the density of the material cannot be accurately identified. In the sensor device, it is possible to reduce the rolling of the liquid surface around the pair of electrodes. Therefore, an error in identifying the density of the material due to the rolling of the liquid surface may be suppressed from occurring.

In another aspect of the present teachings, the base portion may include a substrate having a shape of a flat plate. The pair of electrodes may be disposed on one surface of the substrate. The wall may oppose the one surface of the substrate. In this configuration, the substrate is disposed on the one side of the pair of electrodes. Therefore, the liquid mainly flows from the other side of the pair of electrodes to the pair of electrodes. If the one surface of the base portion on which the pair of electrodes is disposed and the wall oppose each other, the flow of the liquid flowing from the other side of the pair of electrodes to the pair of electrodes is effectively suppressed by the wall. As a result, the rolling of the liquid surface around the pair of electrodes may be effectively reduced.

In another aspect of the present teachings, the sensor device may further comprise a reservoir cup configured to be integrally formed with the filter portion. With this configuration, the number of components of the sensor device may be reduced.

In another aspect of the present teachings, the pair of electrodes may be disposed on one surface of the base portion. The wall may oppose the one surface of the base portion. The filter may extend in the depth direction. The filter may be disposed on two opposing sides with an opposing surface of the wall that opposes the base portion and the one surface of the base portion intervened in between. A clearance between the opposing surface of the wall and the one surface of the base portion may gradually decrease from the filter on one opposing side toward the other opposing side, and then gradually increase toward the filter on the other opposing side. The liquid flows into the filter portion from the filter on the one opposing side and flows toward the filter on the other opposing side. Since the clearance between the opposing surface of the wall and the one surface of the base portion gradually decreases, a flow velocity of the liquid flowing from the filter on the one opposing side toward the other opposing side gradually increases. With this configuration, foreign matters contained in the liquid less easily adhere to the pair of electrodes disposed on the one surface of the base portion. The foreign matters adhering to the pair of electrodes may be removed with the liquid.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved sensor device, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### First Embodiment

### Configuration of a Sensor Device 10

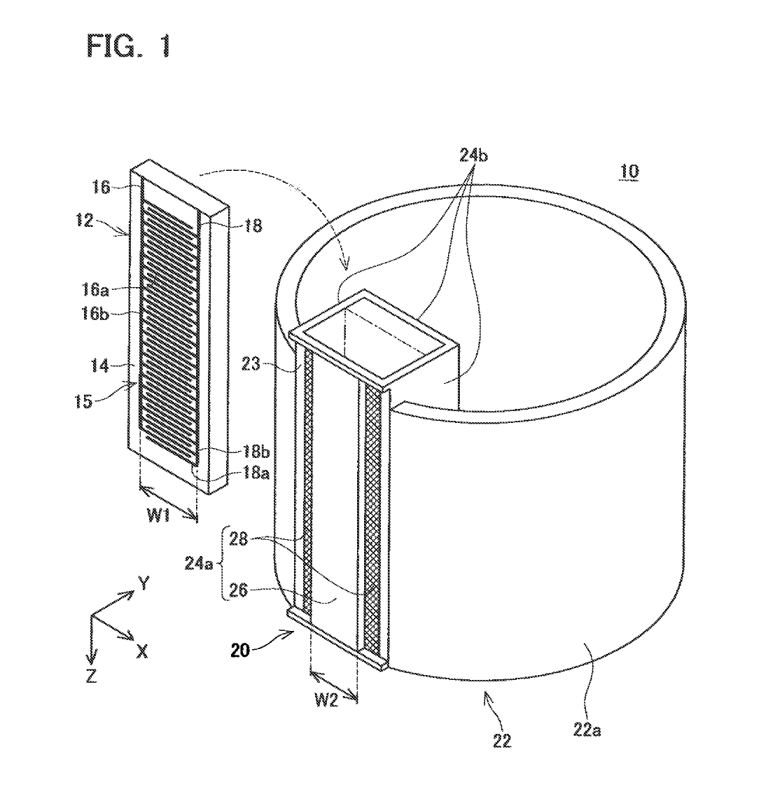

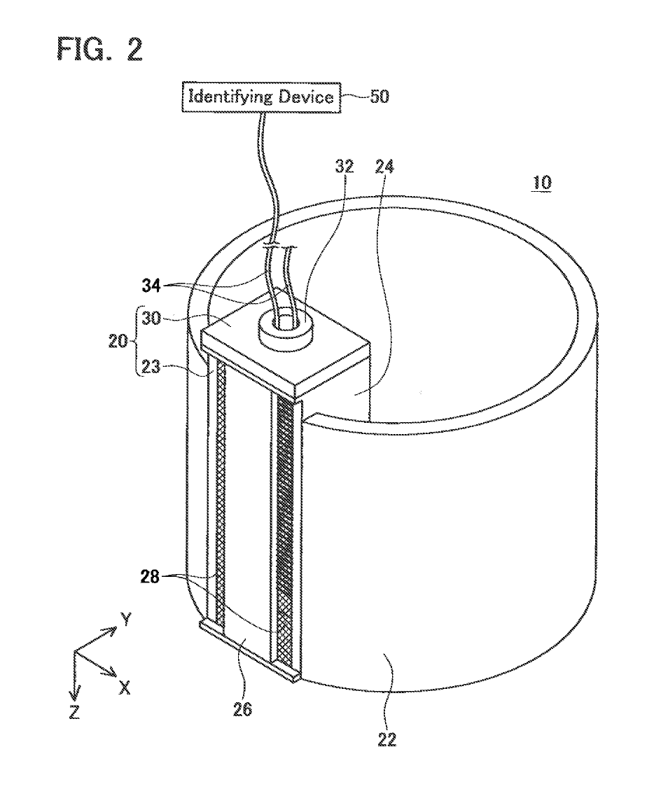

As shown in FIG. 1, a sensor device 10 comprises a detecting portion 12, a filter portion 20, and a reservoir cup 22. The detecting portion 12, the filter portion 20, and the reservoir cup 22 are disposed in a fuel tank (not shown) of an automobile and used for identifying a level of fuel. As shown in FIG. 2, the sensor device 10 further includes an identifying device 50.

As shown in FIG. 1, the detecting portion 12 includes a substrate 14 and a pair of electrodes 15. The substrate 14 has a shape of a flat plate. The substrate 14 extends in a depth direction of the fuel tank (a Z direction). The pair of electrodes 15 is disposed on one surface of the substrate 14. The pair of electrodes 15 extends in the depth direction of the fuel tank (the Z direction). In other words, the substrate 14 and the pair of electrodes 15 are disposed such that a longitudinal direction thereof is parallel to the depth direction of the fuel tank. The pair of electrodes 15 includes a signal electrode 16 and a reference electrode 18.

The signal electrode 16 comprises a plurality of (twenty-two in FIG. 1) first electrodes 16a (in FIG. 1, a reference sign is affixed to only one first electrode 16a) and a second electrode 16b. The second electrode 16b linearly extends in the longitudinal direction of the substrate 14 (the Z direction). The second electrode 16b is connected to one ends (ends on a left side of FIG. 1) of the plurality of first electrodes 16a. Consequently, the plurality of first electrodes 16a is electrically connected to the second electrode 16b. The plurality of first electrodes 16a is disposed in parallel to one another and disposed perpendicularly to the second electrode 16b. The plurality of first electrodes 16a is disposed at an equal interval in the longitudinal direction of the substrate 14. In a state in which the substrate 14 is disposed in the fuel tank, the plurality of first electrodes 16a extends in a direction perpendicular to the depth direction of the fuel tank (parallel to an X direction). The plurality of first electrodes 16a is disposed at the equal interval in the depth direction of the fuel tank. The second electrode 16b extends in the depth direction of the fuel tank.

The reference electrode 18 includes a plurality of (twenty-two in FIG. 1) third electrodes 18a (in FIG. 1, a reference sign is affixed to only one third electrode 18a) and a fourth electrode 18b. The fourth electrode 18b linearly extends in the longitudinal direction of the substrate 14. The fourth electrode 18b is connected to one ends (ends on a right side of FIG. 1) of the plurality of third electrodes 18a. Consequently, the plurality of third electrodes 18a is electrically connected to the fourth electrode 18h. The plurality of third electrodes 18a is disposed in parallel to one another and disposed perpendicularly to the fourth electrode 18b. The plurality of third electrodes 18a is disposed at an equal interval in the longitudinal direction of the substrate 14. When viewed along the longitudinal direction of the substrate 14, the first electrodes 16a and the third electrodes 18a are alternately disposed. In a state in which the substrate 14 is disposed in the fuel tank, the plurality of third electrodes 18a extends in the direction perpendicular to the depth direction of the fuel tank. The plurality of third electrodes 18a is disposed at the equal interval in the depth direction of the fuel tank. The fourth electrode 18b extends in the depth direction of the fuel tank.

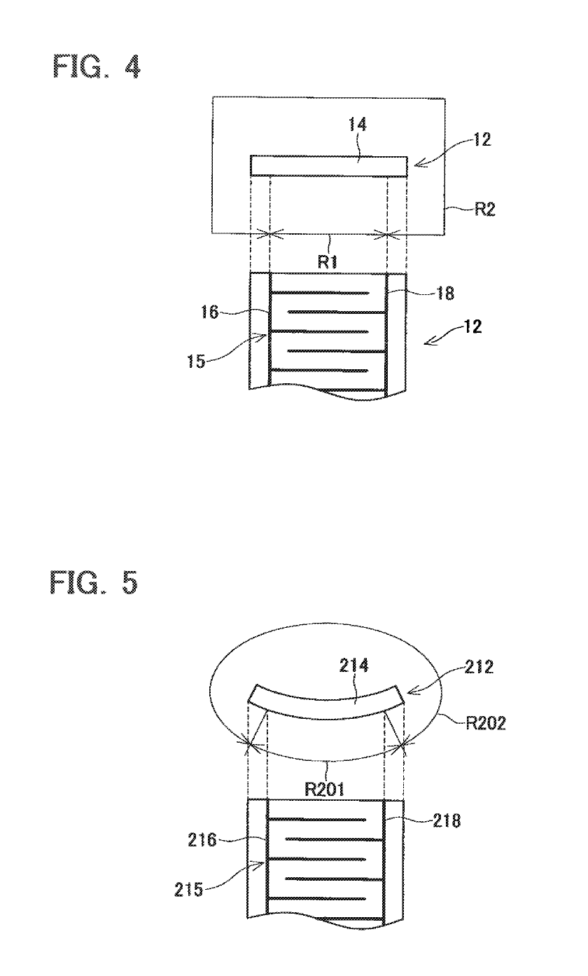

As shown in FIG. 4, a measuring range R1 of the detecting portion 12 is a range in which the pair of electrodes 15 is provided in a circumferential direction with the substrate 14 at a center, which may alternatively be said as a circumferential direction with a center axis of the substrate 14 at the center, in a state in which the detecting portion 12 is viewed from right above. A non-measuring range R2 of the detecting portion 12 is a range in which the pair of electrodes 15 is not provided in the circumferential direction with the substrate 14 at the center in the state in which the detecting portion 12 is viewed from right above. More accurately, in a plane perpendicular to the longitudinal direction of the substrate 14, there are two regions between a straight line extending perpendicularly to the substrate 14 from the left end of the signal electrode 16 and a straight line extending perpendicularly to the substrate 14 from the right end of the reference electrode 18. Of the two regions, the measuring range R1 is the region on a side where the pair of electrodes 15 is provided and the non-measuring range R2 is the region on a side where the pair of electrodes 15 is not provided.

Referring hack to FIG. 1, the reservoir cup 22 has a bottomed cylindrical shape, in other words a cup shape. A filter portion 20 is disposed in a part of a sidewall 22a of the reservoir cup 22.

The filter portion 20 includes a housing portion 23 having a bottomed square cylindrical shape and a lid 30 (see FIG. 2) that closes an opening at an upper end of the housing portion 23. Among sidewalls 24a and 24b in four directions of the housing portion 23, one sidewall 24a is exposed to an outer side of the reservoir cup 22 from the sidewall 22a of the reservoir cup 22. Three sidewalls 24b are disposed further on an inner side of the reservoir cup 22 than the sidewall 22a of the reservoir cup 22.

The three sidewalls 24b are formed of a material (e.g., resin) identical with a material of the reservoir cup 22. The three sidewalls 24b do not allow the file to permeate. The sidewall 24a includes a filter 28 and a wall 26. The wall 26 opposes the pair of electrodes 15 in a state in which the detecting portion 12 is disposed in the housing portion 23. The wall 26 is disposed in parallel to the substrate 14. A width (a length in the X direction) W2 of the wall 26 is formed larger than a width (a length in the X direction) W1 of the pair of electrodes 15. That is, the wall 26 is disposed in an entire range of the measuring range R1 in the plane perpendicular to the longitudinal direction of the substrate 14. A height (a length in the Z direction) of the wall 26 is formed larger than a height (a length in the Z direction) of the detecting portion 12. The wall 26 is formed of a material identical with the material of the sidewalls 24b and the reservoir cup 22. The wall 26 does not allow the fuel to permeate.

Portions of the filter 28 are respectively disposed on both sides in a latitudinal direction of the wall 26 (the X direction). The filter 28 is formed of non-woven fabric.

As indicated by a broken line arrow in FIG. 1, the detecting portion 12 is housed in the housing portion 23 in a direction in which the pair of electrodes 15 opposes the wall 26 (see an alternate long and Short dash line in FIG. 1). As shown in FIG. 2, when the detecting portion 12 is housed, the opening at the upper end of the housing portion 23 is closed by the lid 30.

The lid 30 includes a connector 32 and two harnesses 34. In assembling the lid 30 to the housing portion 23, an operator connects the signal electrode 16 to one harness 34 via the connector 32 and connects the reference electrode 18 to the other harness 34. The one harness 34 is connected to an oscillation circuit (not shown) via a resistor (not shown). The other harness 34 is grounded.

The lid 30 and a bottom of the housing portion 23 are formed of a material, e.g., resin, identical with the material of the reservoir cup 22. That is, the lid 30 and the bottom do not allow the fuel to permeate.

The three sidewalls 24b and the wall 26 of the housing portion 23 are integrally formed with the reservoir cup 22 by, for example, injection molding. Consequently, it is possible to reduce the number of components of the sensor device 10 compared with the Dumber of components required when the housing portion 23 and the reservoir cup 22 are separately provided.

The identifying device 50 is connected between the signal electrode 16 and the resistor. A signal identical with (or correlating to) a signal input to the signal electrode 16 is input to the identifying device 50. The identifying device 50 may detect the signal input to the signal electrode 16. The identifying device 50 has stored therein in advance a database indicating a correlation between a magnitude of the signal input thereto and a level of the fuel in the fuel tank.

A method of using the sensor device 10 is explained below. In a state in which the housing portion 23 and the reservoir cup 22 are housed in the fuel tank, the fuel in the fuel tank permeates through the filter 28 and intrudes into the housing portion 23. Since the housing portion 23 except the filter 28 is formed of a material that does not allow the fuel to permeate, the fuel intrudes only from the filter 28 of the housing portion 23. The fuel tank and the housing portion 23 communicate with each other via the filter 28. Therefore, a level of the fuel in the housing portion 23 is identical with the level of the fuel in the fuel tank.

When an engine of the automobile starts, a signal (i.e., a voltage) is supplied from the oscillation circuit to the signal electrode 16. As a result, electrical charges are accumulated in the pair of electrodes 15. Capacitance of the pair of electrodes 15 changes according to a length of the pair of electrodes 15 immersed in the fuel. That is, the capacitance of the pair of electrodes 15 changes in correlation with the level of the fuel in the housing portion 23 (the level of the fuel in the fuel tank). As a result, the signal input to the identifying device 50 changes in correlation with the level of the fuel in the fuel tank. The identifying device 50 identifies the level of the fuel in the fuel tank using the input signal and the database.

For example, the fuel in the fuel tank sometimes rolls because of vibration of the automobile. If a liquid surface of the fuel in the housing portion 23 rolls up and down because the fuel in the fuel tank rolls and flows, the length of the pair of electrodes 15 immersed in the fuel changes although an amount of the fuel in the fuel tank does not change. As a result, the identifying device 50 sometimes misidentifies the level of the fuel in the fuel tank. In the housing portion 23, the wall 26 that does not allow the fuel to permeate is provided in the position opposing the pair of electrodes 15 (i.e., the measuring range R1). Therefore, the fuel in the housing portion 23 can be suppressed from rolling by the wall 26. Consequently, it is possible to reduce an influence on the identification of the level of the fuel such as an identification error due to the rolling of the liquid surface of the fuel.

The detecting portion 12 is surrounded by the housing portion 23. The housing portion 23 except the filter 28 of the sidewall 24a does not allow the fuel to permeate. The filter 28 is made of non-woven fabric. The fuel intruding into the housing portion 23 is the fuel that permeates through the filter 28. While the fuel permeates through the filter 28, foreign matters and air bubbles in the fuel are removed from the fuel by the filter 28. Consequently, the capacitance of the pair of electrodes 15 is prevented from changing because of adhesion of foreign matters and the like to the pair of electrodes 15.

The width of the wall 26 is larger than the width of the pair of electrodes 15. The height of the wall 26 is larger than the height of the pair of electrodes 15. Consequently, the rolling of the liquid surface in the housing portion 23 is effectively suppressed.

A part of a peripheral wall of the housing portion 23 is the filter 28. Therefore, a difference in the liquid surface between an inside and an outside of the housing portion 23 is suppressed from occurring.

The pair of electrodes 15 is formed on one surface of the substrate 14. Therefore, the fuel mainly flows toward the pair of electrodes 15 from an opposite side of a side where the substrate 14 is disposed. The wall 26 is provided on the opposite side of the side of the pair of electrodes 15 where the substrate 14 is provided. Therefore, the flow of the fuel by the wall 26 is effectively suppressed.

### Second Embodiment

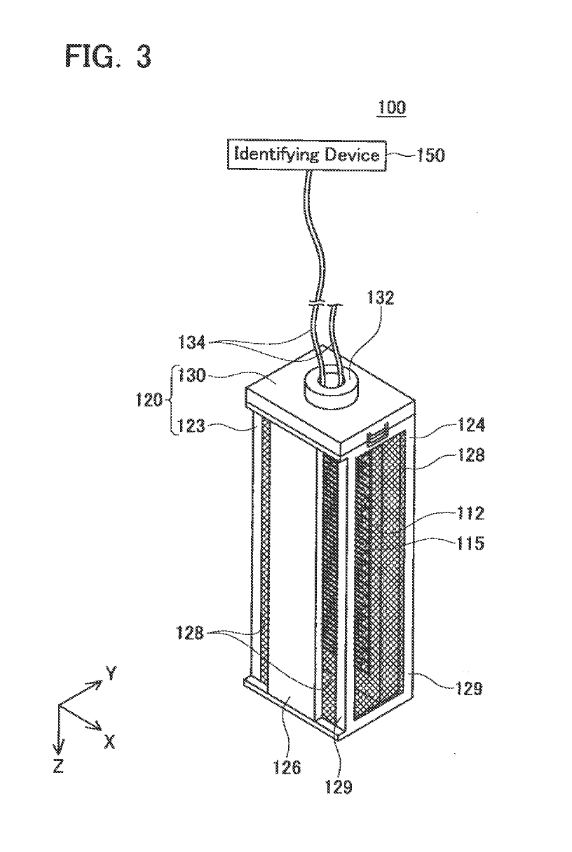

As shown in FIG. 3, a sensor device 100 includes a detecting portion 112, a filter portion 120, and an identifying device 150. The detecting portion 112 and the filter portion 120 of the sensor device 100 are disposed in a fuel tank (not shown) of an automobile in which mixed fuel is stored. The detecting portion 112 and the filter portion 120 are used to identify a density of ethanol contained in the mixed fuel.

The detecting portion 112 has a configuration similar to the configuration of the detecting portion 12 in the first embodiment. However, a height (a length in the Z direction) of the detecting portion 112 is smaller than the height (the length in the Z direction) of the detecting portion 12. Specifically, the height of the detecting portion 112 is set to a height enough for maintaining a state in which the entire detecting portion 112 is ordinarily immersed in the fuel in the fuel tank.

The filter portion 120 includes a housing portion 123 having a bottomed square cylindrical shape and a lid 130 that closes an opening at an upper end of the housing portion 123. Each of sidewalls 124 in four directions of the housing portion 123 includes a filter 128 and a frame 129 that supports the filter 128 from the four directions. The filter 128 is made of non-woven fabric. The frame 129 is formed of a material that does not allow the fuel to permeate.

On the sidewall 124 of the detecting portion 112 opposing a pair of electrodes 115, a wall 126 is provided in a position opposing the pair of electrodes 115. The wall 126 is disposed in parallel to a substrate of the detecting portion 112. A width (a length in the X direction) of the wall 126 is thrilled larger than a width (a length in the X direction) of the pair of electrodes 115. The wall 126 is formed of a material identical with a material of the frame 129. That is, the wall 126 does not allow the fuel to permeate.

The lid 130 has a configuration similar to the configuration of the lid 30 in the first embodiment. Specifically, one electrode of the pair of electrodes 115 is connected to one harness 134 via a connector 132 and the other electrode is connected to the other harness 134 via the connector 132. The one harness 134 is connected to an oscillation circuit (not shown) via a resistor (not shown). The other harness 134 is grounded. A bottom of the housing portion 123 is formed of a material (e.g., resin) identical with the material of the frame 129. That is, the lid 130 and the bottom do not allow the fuel to permeate.

Like the identifying device 50, the identifying device 150 is connected between the one electrode of the pair of electrodes 115 and the resistor. The identifying device 150 stores therein in advance a database indicating a correlation between a magnitude of a signal input to the identifying device 150 and the density of the ethanol contained in the mixed fuel.

A method of using the sensor device 100 is explained below. In a state in which the detecting portion 112 and the filter portion 120 are housed in the fuel tank, the fuel permeates through the filter 128 and intrudes into the housing portion 123. Consequently, the entire detecting portion 112 is immersed in the fuel. The fuel tank and the housing portion 123 communicate with each other via the filter 128. Therefore, a level of the fuel in the housing portion 123 is identical with a level of the fuel in the fuel tank.

When an engine of the automobile starts, a signal (i.e., a voltage) is supplied from the oscillation circuit to an electrode. As a result, electric charges are accumulated in the pair of electrodes 115. Capacitance of the pair of electrodes 115 changes according to the density of the ethanol contained in the fuel. As a result, the signal input to the identifying device 150 changes in correlation with the density of the ethanol contained in the fuel. The identifying device 150 identifies the density of the ethanol contained in the fuel using the input signal and the database.

At this point, if the liquid surface of the fuel in the housing portion 123 rolls up and down because the fuel rolls, at least a part of the pair of electrodes 115 is sometimes exposed to an outside of the fuel. In this case, the capacitance of the pair of electrodes 115 changes although the density of the ethanol does not change. As a result, the identifying device 150 misidentifies the density of the ethanol. In the housing portion 123, the wall 126 that does not allow the fuel to permeate is provided in a position opposing the pair of electrodes 115. Therefore, the fuel in the housing portion 123 can be suppressed from rolling by the wall 126. Consequently, an influence on the identification of the level of the fuel due to the rolling of the liquid surface of the fuel is reduced.

The housing portion 123 of the side wall except the wall 126 and the frame 129 is formed by the filter 128. With this configuration, a difference in the liquid surface level of the fuel between an inner side and an outer side of the housing portion 123 is prevented from occurring.

According to the second embodiment, as in the second embodiment, the capacitance of the pair of electrodes 115 is prevented from changing because of adhesion of foreign matters and the like to the pair of electrodes 115.

### Modifications

(1) In the embodiments, the walls 26 and 126 are formed of the material that does not allow the fuel to permeate. However, the walls 26 and 126 may be formed of a material that allows the fuel to permeate. The walls 26 and 126 may have a fuel permeability lower than that of the filters 28 and 128.

(2) In the above embodiment, the pair of electrodes 15 is disposed on the one surface of the substrate 14 having the shape of the flat plate. However, a pair of electrodes may be provided on a substrate other than the substrate having the shape of the flat plate. For example, as shown in FIG. 5, a detecting portion 212 may include a curved substrate 214. A pair of electrodes 215 may be disposed on a curved surface of the curved substrate 214. In this modification, a measuring range R201 of the detecting portion 212 may be a range in which a pair of electrodes 215 is provided in a circumferential direction around the substrate 214, which may alternatively be defined as around a center axis of the substrate 214, in a state in which the detecting portion 212 is viewed from right above. A non-measuring range R202 of the detecting portion 212 may be a range in which the pair of electrodes 215 is not provided in the circumferential direction around the substrate 214 in the state in which the detecting portion 212 is viewed from right above. More accurately, in a plane perpendicular to a longitudinal direction of the substrate 214, there may be two regions between a first straight line and second straight line. The first straight line may extend perpendicularly to a tangential line the substrate 214 at a left end of a signal electrode 216. The second straight line may extend perpendicularly to a tangential line of the substrate 214 at a right end of a reference electrode 218. Of the two regions, the measuring range R201 may be a region on a side where the pair of electrodes 215 is provided and the non-measuring range R202 may be a region on a side where the pair of electrodes 215 is not provided. In this modification, at least a part of a wall may be located within the measuring range R201.

For example, a pair of electrodes may be disposed on a side surface of a base portion having a cylindrical shape to extend in an axis direction of the cylindrical shape. In this case, at least a part of a wall is desirably located in a measuring range in which the pair of electrodes is provided in a circumferential direction around the base portion. More specifically, at least a part of the wall is desirably located in a measuring range including the pair of electrodes and the side surface of the base portion between the pair of electrodes. In this case, the wall may be curved along the cylindrical shape.

(3) In the embodiments, the walls 26 and 126 are provided in parallel to the substrates 14 of the detecting portions 12 and 112. However, walls do not have to be provided in parallel to the substrates 14 of the detecting portions 12 and 112. For example, the walls may be curved.

(4) In the first embodiment, the sensor device 10 identifies the level of the fuel. On the other hand, in the second embodiment, the sensor device 100 identifies the density of the ethanol in the fuel. However, a sensor device may identify both of the level of the fuel and the density of the ethanol in the fuel. For example, a detecting portion may include a pair of electrodes for identifying the level of the fuel and a pair of electrodes for identifying the density of the ethanol in the fuel.

### Third Embodiment

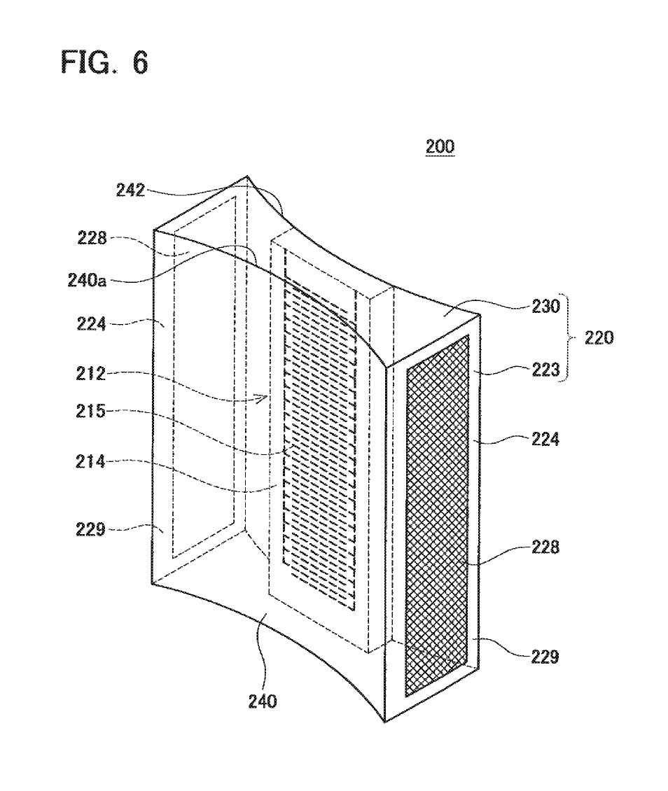

As shown in FIG. 6, like the sensor device 100, a sensor device 200 is used to identify ethanol density. The sensor device 200 comprises the detecting portion 212, a filter portion 220, and an identifying device (not shown). The identifying device is identical with the identifying device 150 in the second embodiment. The detecting portion 212 is identical with the detecting portion 112 in the second embodiment and includes the substrate 214.

The filter portion 220 comprises a housing portion 223 having a bottomed box shape and a lid 230 that closes an opening at an upper end of the housing portion 223. The lid 230 has a configuration similar to the configuration of the lid 130 in the second embodiment. However, an external shape of the lid 230 is a shape extending along a shape formed by sidewalls 240, 242, 224, and 224 in four directions explained below. Although not shown, the lid 230 comprises a connector. The pair of electrodes 215 of the detecting portion 212 is connected to a harness via the connector.

The housing portion 223 comprises the sidewalls 240, 242, 224, and 224 in the four directions. In FIG. 6, thicknesses of the sidewalls 240, 242, 224, and 224 and the lid 230 are not shown. The two sidewalls 224 have a shape of a flat plate. The two sidewalls 224 are disposed in parallel spaced apart from each other. Each of the two sidewalls 224 comprises a filter 228 and a frame 229 that supports the filter 228 from the four directions. The filter 228 is made of non-woven fabric. The filter 228 extends along a depth direction of a fuel tank (an up-down direction in FIG. 6). The frame 229 is formed of a material that does not allow fuel to permeate.

The sidewalls 240 and 242 are disposed between the two sidewalls 224. The sidewall 240 and the sidewall 242 are disposed to oppose each other. The sidewall 240 is curved over an entire length in the depth direction of the fuel tank (the up-down direction in FIG. 6) to project toward the sidewall 242. Similarly, the sidewall 242 is curved to project toward the sidewall 240. The sidewalls 240 and 242 are formed of a material that does not allow the fuel to permeate.

The detecting portion 212 is disposed on a surface of the sidewall 242 opposing the sidewall 240. An opposing surface 240a of the sidewall 240 opposing the sidewall 242 opposes the pair of electrodes 215 disposed on the one surface of the substrate 214. That is, in the housing portion 223, two filters 228 are disposed on two opposing sides of the opposing surface 240a and the substrate 214 with the opposing surface 240a and the one surface of the base substrate 214 intervened in between.

The fuel passes through one filter 228 and flows into the housing portion 223. The fuel flown into the housing portion 223 flows toward the other filter 228, passes through the other filter 228, and flows into the fuel tank. In the housing portion 223, since the sidewalls 240 and 242 are curved, a clearance between the sidewalls 240 and 242 gradually decreases from the one filter 228 toward the other filter 228 and then gradually increases toward the other filter 228. In this configuration, the clearance between the surface of the sidewall 240 opposing the one surface of the substrate 214 and the one surface of the substrate 214 (the surface on which the pair of electrodes 215 are disposed) gradually decreases from the one filter 228 toward the other filter 228 and then gradually increases toward the other filter 228. More specifically, when viewed in a cross section perpendicular to a direction in which the pair of electrodes 215 extends, which is the depth direction of the fuel tank, the clearance between the surface of the sidewall 240 opposing the one surface of the substrate 214 and the one surface of the substrate 214 gradually decreases from the one filter 228 toward the other filter 228 and then gradually increases toward the other filter 228. The clearance between the surface of the sidewall 240 opposing the one surface of the substrate 214 and the one surface of the substrate 214 is the narrowest at a center of the one surface of the substrate 214 in a direction perpendicular to the direction in which the pair of electrodes 215 extends. As a result, a flow velocity of the fuel flown into the housing portion 223 gradually increases toward the other filter 228. With this configuration, it is possible to increase a flow velocity of the fuel flowing on the pair of electrodes 215. Consequently, foreign matters in the fuel are suppressed from adhering to the pair of electrodes 215. Further, the foreign matters adhering to the pair of electrodes 215 is removed by the fuel.

The sensor device 200 according to the third embodiment attains effects similar to the effects of the sensor device 100 according to the second embodiment.

### Fourth Embodiment

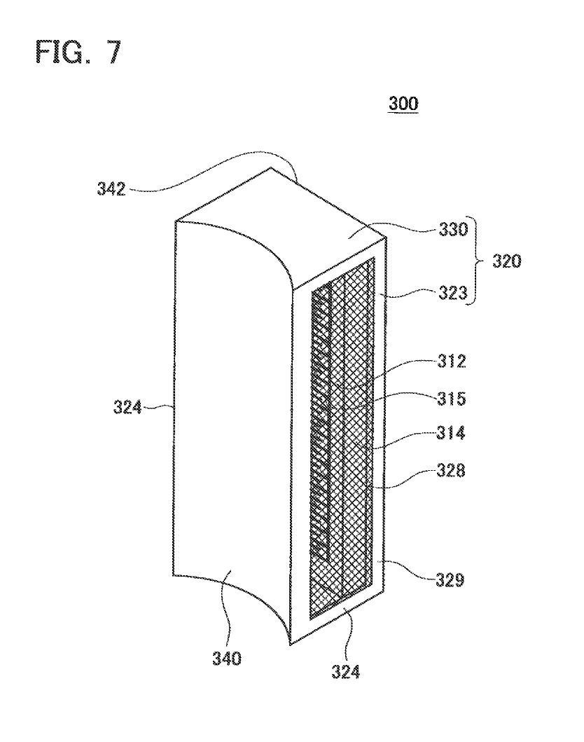

Differences of a fourth embodiment from the third embodiment are explained with reference to FIG. 7. A detecting portion 312 and an identifying device (not shown) of a sensor device 300 are identical with the detecting portion 212 and the identifying device in the third embodiment.

A filter portion 320 comprises a housing portion 323 having a bottomed box shape and a lid 330 that closes an opening at an upper end of the housing portion 323. The lid 330 has a configuration similar to the configuration of the lid 230. However, an external shape of the lid 330 is a shape extending along a shape formed by sidewalls 340, 342, 324, and 324 in four directions explained below. The housing portion 323 comprises the sidewalls 340, 342, 324, and 324 in the four directions. Each of the two sidewalls 324 is similar to the sidewalls 224. That is, the sidewall 324 comprises a filter 328 and a frame 329. The filter 328 extends along a depth direction of a fuel tank (an up-down direction in FIG. 7).

The sidewall 342 has a shape of a fiat plate. The sidewall 342 is formed of a material that does not allow fuel to permeate. The detecting portion 312 is disposed on a surface of the sidewall 342 opposing the sidewall 340. The sidewall 340 is curved over an entire length in the depth direction of the fuel tank (the up-down direction in FIG. 7) to project toward the sidewall 342. The sidewall 340 is formed of a material that does not allow the fuel to permeate. An opposing surface of the sidewall 340 opposing the sidewall 342 opposes a pair of electrodes 315 disposed on one surface of a substrate 314 of the detecting portion 312. That is, in the housing portion 323, two filters 328 are disposed on two opposing sides of an opposing surface opposing one surface of the detecting portion 312 of the sidewall 340 and the substrate 314, with this opposing surface and the substrate 314 intervened in between.

With this configuration, effects similar to the effects of the third embodiment can be attained.

### Fifth Embodiment

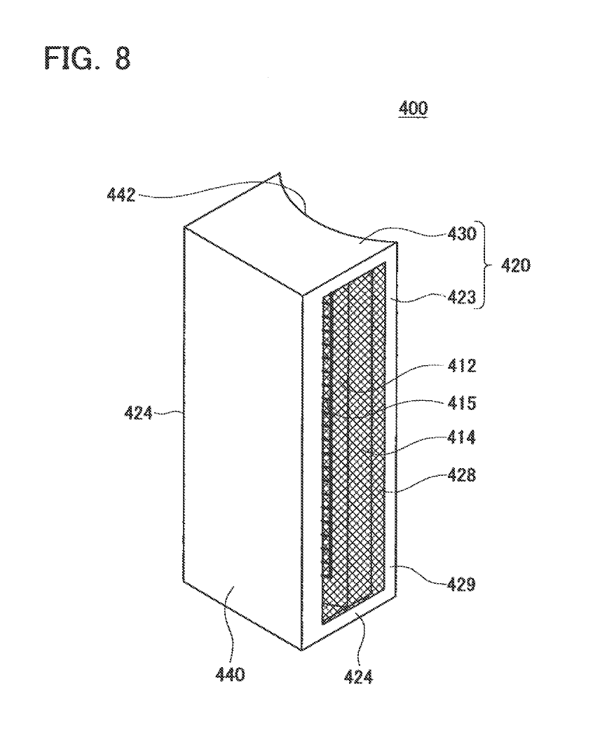

Differences of a fifth embodiment from the third embodiment are explained with reference to FIG. 8. An identifying device (not shown) of a sensor device 400 is the same as the identifying device in the third embodiment.

A filter portion 420 includes a housing portion 423 having a bottomed box shape and a lid 430 that closes an opening at an upper end of the housing portion 423. The lid 430 has a configuration similar to the configuration of the lid 230. However, an external shape of the lid 430 is a shape extending along a shape formed by sidewalls 440, 442, 424, and 424 in four directions explained below. The housing portion 423 includes the sidewalls 440, 442, 424, and 424 in the four directions. Each of the two sidewalls 424 is identical with the sidewalls 224. That is, the sidewall 424 includes a filter 428 and a frame 429. The filter 428 extends along a depth direction of a fuel tank (an up-down direction in FIG. 8).

The sidewall 440 has a shape of a flat plate. The sidewall 440 is formed of a material that does not allow fuel to permeate. The sidewall 442 is curved over an entire length in the depth direction of the fuel tank (the up-down direction in FIG. 8) to project toward the sidewall 440. A detecting portion 412 is disposed on a surface of the sidewall 442 opposing the sidewall 440. Therefore, an opposing surface of the sidewall 440 opposing the sidewall 442 opposes a pair of electrodes 415 disposed on one surface of the detecting portion 412.

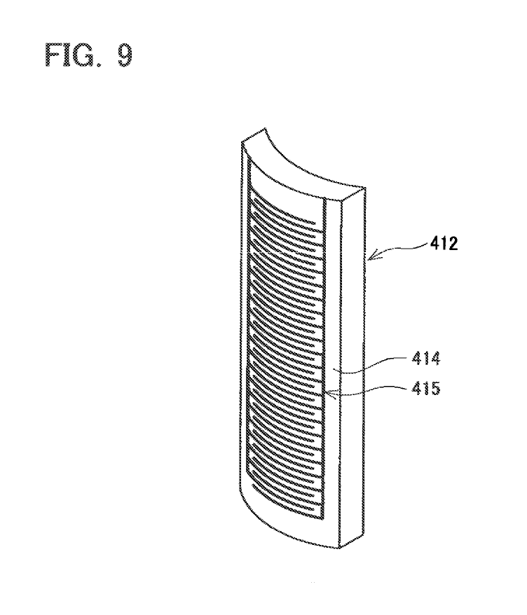

As shown in FIG. 9, the detecting portion 412 comprises a substrate 414 and the pair of electrodes 415. The substrate 414 curves along a shape of a surface of the sidewall 442 opposing the sidewall 440. The pair of electrodes 415 is disposed along a shape of one surface of the substrate 414. Therefore, in the housing portion 423, two filters 428 are disposed on two opposing sides of an opposing surface opposing one surface of the detecting portion 412 of the sidewall 440 and the substrate 414, with this opposing surface and the substrate 414 intervened in between.

With this configuration, effects similar to the effects of the third embodiment can be attained.

### Modifications

(1) In the third embodiment, the sidewall 240 is curved in a direction in which the sidewall 240 projects toward the sidewall 242 opposing the sidewall 240. However, the sidewall 240 does not have to be curved. For example, the sidewall 240 may include a first flat plate inclining from an end side on one filter 228 side toward the sidewall 242 and a second flat plate inclining from an end side on the other filter 228 side toward the sidewall 242. The first flat plate and the second flat plate may be directly connected between the two filters 228. Alternatively, the first flat plate and the second flat plate may be connected via a third flat plate disposed in a center between the two filters 228. The third flat plate may be disposed in parallel to the one surface of the substrate 214. The same applies to the sidewall 242 and the like. With this configuration, a clearance between an opposing surface of the sidewall 240 opposing the one surface of the substrate 214 and the one surface of the substrate 214 gradually decreases from one filter 228 toward the other filter 228 and then gradually increases toward the other filter 228. The same applies to the sidewall 340 in the fourth embodiment and the sidewall 442 in the fifth embodiment. As a modification of the third embodiment, the sidewall 240 may be curved and the sidewall 242 may have a shape including the first flat plate and the second flat plate. That is, the sidewall 240 and the sidewall 242 may have different shapes.

(2) In the third to fifth embodiments, the sidewall 240 and the like are curved. However, the opposing surface 240a and the like of the sidewall 240 and the like may be curved and, on the other hand, the surfaces of the sidewall 240 and the like on the opposite side of the sidewall 242 and the like may be flat.

(3) The filter portion 320 and the like in the third to fifth embodiments may be integrally formed with a reservoir cup.

(4) In the third embodiment, the sidewall 240 may be parallel to the one surface of the substrate 214 in a position closest to the one surface of the substrate 214. In other words, a clearance between a surface of the sidewall 240 opposing the substrate 214 and the one surface of the substrate 214 may gradually decrease from one filter 228 toward the other filter 228 and then gradually increases toward the other filter 228 through a section where the clearance is fixed.

1. A sensor device comprising:
a base portion configured to extend in a depth direction of a container when the base portion is disposed within the container containing liquid;
a pair of electrodes configured to attach to a surface of the base portion and extend in the depth direction of the container; and
a filter portion configured to surround the pair of electrodes,
wherein in a plan view perpendicular to the depth direction of the container, a measuring range in which the pair of electrodes is disposed and a non-measuring range in which the pair of electrodes is not disposed are provided in a circumferential direction with the base portion at a center,
the filter portion comprises a filter, and a wall having a lower liquid permeability than the filter, and
at least a part of the wall is located within the measuring range.

2. The sensor device as in claim 1, further comprising:
an identifying device configured to identify a level of the liquid, a density of a specific material contained in the liquid, or a combination thereof based on a signal supplied to the pair of electrodes.

3. The sensor device as in claim 1, wherein
the base portion includes a substrate having a shape of a flat plate,
the pair of electrodes is disposed on one surface of the substrate, and
the wall opposes the one surface of the substrate.

4. The sensor device as in claim 1, further comprising:
a reservoir cup configured to be integrally formed with the filter portion.

5. The sensor device as in claim 1, wherein
the pair of electrodes is disposed on one surface of the base portion,
the wall opposes the one surface of the base portion,
the filter extends in the depth direction,
the filter is disposed on two opposing sides with an opposing surface of the wall that opposes the base portion and the one surface of the base portion intervened in between, and
a clearance between the opposing surface of the wall and the one surface of the base portion gradually decreases from the filter on one opposing side toward the other opposing side, and then gradually increases toward the filter on the other opposing side.
